(19) United States
(12) Patent Application Publication
(10) Pub. No.: US 2006/0023899 A1
(43) Pub. Date: Feb. 2, 2006

(54) Wireless microphone with display function

(75) Inventor: Chia-Chun Tung, Taipei City (TW)

Correspondence Address: BACON & THOMAS, PLLC, 625 SLATERS LANE, FOURTH FLOOR, ALEXANDRIA, VA, 22314, US

(73) Assignee: BlueExpert Technology Corp., Taipei City (TW)

(21) Appl. No.: 11/011,078

(22) Filed: Dec. 15, 2004

(30) Foreign Application Priority Data
Jul. 29, 2004 (TW) 093122700

(51) Int. Cl. H04R 3/00; H04R 9/08; H04R 21/02

(52) U.S. Cl. 381/113; 381/361

(57) ABSTRACT

A wireless microphone with a display function comprises a microphone body, a display, a sound receiving unit and a memory module. The microphone body has a hand-held portion, and a frame portion. The frame portion is connected with the hand-held portion and has a first opening and a second opening. The display is disposed in the first opening of the frame portion. The sound receiving unit is disposed in the second opening of the frame portion. The sound receiving unit receives at least a sound signal. The memory module is electrically connected with the display. The memory module saves at least one display information, which is shown on the display.

### CROSS REFERENCE TO RELATED APPLICATIONS

This Non-provisional application claims priority under 35 U.S.C. §119(a) on Patent Application No(s). 093122700 filed in Taiwan, Republic of China on Jul. 29, 2004, the entire contents of which are hereby incorporated by reference.

### BACKGROUND OF THE INVENTION

1. Field of Invention

The invention relates to a wireless microphone and, in particular, to a wireless microphone with a display function.

2. Related Art

Microphones are indispensable products in many occasions, such as singing in a KTV or speaking in a larger occasion. Most early microphones are wired microphones, which only can be used when a signal line is connected to the microphone jack of the amplifier. When the microphone is used in a short distance, the user may not feel inconvenient. However, when the distance from the amplifier to the microphone is lengthened, it is bothersome in usage because the necessary connection wire is too long. In addition, the modern electrical products are almost developed toward the wireless trend, so the wireless microphones are rapidly developed in correspondence with the demands in the market.

The available wireless microphone simplifies the wire connection of the microphone in many occasions. In a concert, for example, a shower does not have to limit his/her action and movable range on the stage owing to the limitation of the wired microphone, and the wireless microphone can be used more conveniently.

As shown in FIG. 1, the conventional microphone 1 has a rod portion to provide the user to hold, a pickup portion to collect the sound, and a control switch 13 disposed on the rod portion 11. While using the microphone, the user holds it on the rod portion 11, makes the sound pickup portion 12 collect the sound ‘close to the user’s mouth, and controls the microphone 1 with the control switch 13 to turn the switch on or off.

With the progress of the technology, however, the electrical products are also developed toward the multi-functional trend. Thus, the applications of the microphone should not be limited to the sound transmission. In many speech occasions that can be discovered, the speaker usually needs a draft and delivers a speech with the draft to cause the speaker to bend the neck for reading the draft. Thus, the speaker cannot look attentively at the audience below the stage. Furthermore, the singer, for example, also needs to memorize the lyrics in the mind when singing. This is hard to avoid forgetting lyrics, which causes the program imperfect. At this time, it will complete the speech or the program more perfect if there has a convenient display can show the draft or the lyrics.

Thus, it is an important subject of the invention to increase the suitable applications of the microphone in various occasions such that the microphone can have the advantage of multi-functions.

### SUMMARY OF THE INVENTION

As mentioned above, the invention is to provide a microphone with a display function, which can show the information on the microphone.

To achieve the above, a microphone with a display function of the invention includes a microphone body, a display, a sound receiving portion and a memory module. The microphone body has a hand-held portion and a frame portion, which is connected to the hand-held portion, and the frame portion has a first opening and a second opening. The display is disposed in the first opening of the frame portion. The sound receiving portion is disposed in the second opening of the frame portion. The sound receiving portion receives at least a sound signal. The memory module saves at least one display information, which is shown on the display. The memory module is electrically connected to the display.

As mentioned above, the wireless microphone with the display function of the invention has the display disposed on the frame portion. Thus, the user can read the information that they request directly.

### BRIEF DESCRIPTION OF THE DRAWINGS

The invention will become more fully understood from the detailed description given herein below illustration only, and thus is not limitative of the present invention, and wherein:

FIG. 1 is a schematic illustration showing a conventional microphone;

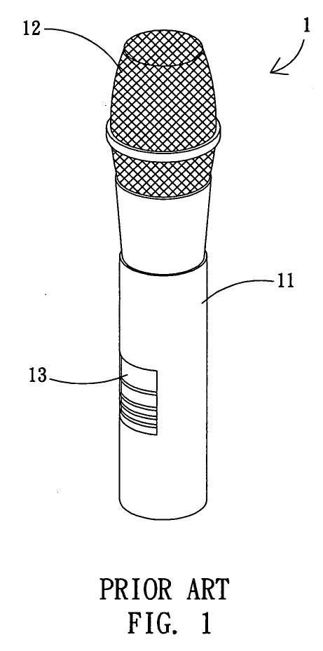

FIG. 2 is a schematic illustration showing a wireless microphone with a display function according to a first embodiment of the invention;

FIG. 3 is another schematic illustration showing a wireless microphone with a display function according to the first embodiment of the invention; and

FIG. 4 is a schematic illustration showing a wireless microphone with a display function according to a second embodiment of the invention.

### DETAILED DESCRIPTION OF THE INVENTION

The wireless microphone with the display function according to the present invention will be described with reference to the accompanying drawings, wherein the same references relate to the same elements.

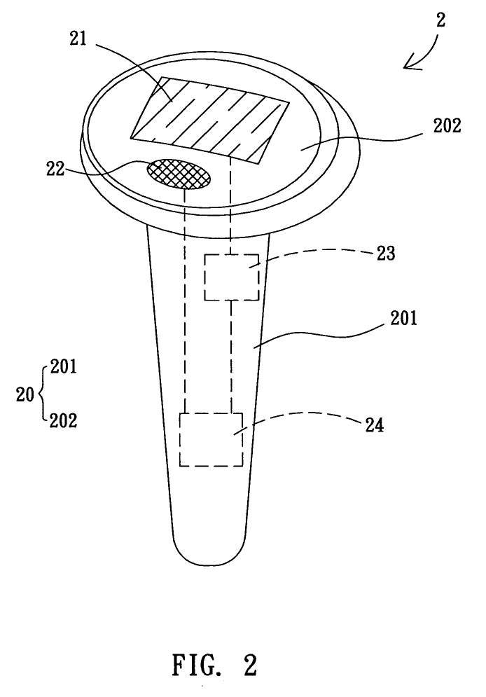

Referring to FIG. 2, the wireless microphone 2 with the display function includes a microphone body 20, a display 21, a sound receiving unit 22, and a memory module 23.

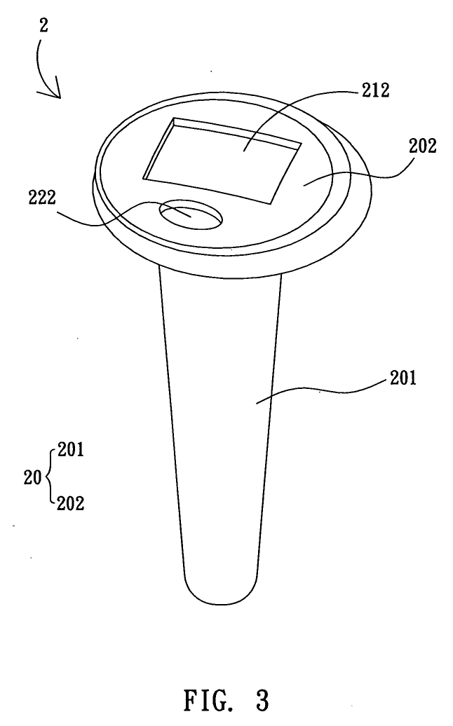

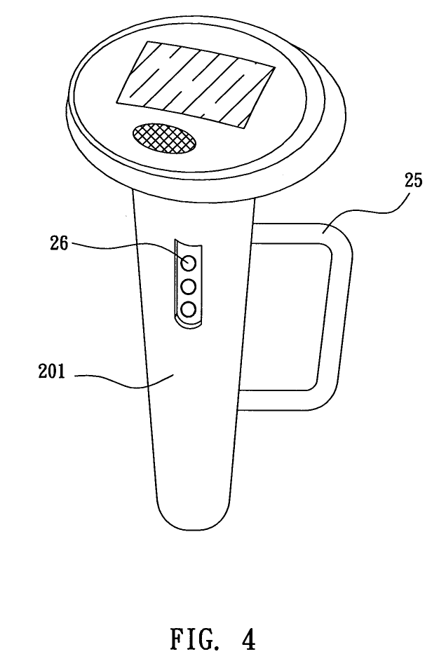

The microphone body 20 has a hand-held portion 201 and a frame portion 202, which is connected to the hand-held portion 201. The frame portion 202 has a first opening 212 and a second opening 222, as shown in FIG. 3. In this embodiment, the hand-held portion 201 and the frame portion 202 is integrally formed, additionally, as shown in FIG. 4, it may disposes a plurality of keys 26 onto the hand-held portion 201, it also may disposed on the frame portion 202, that is, the keys 26 may be disposed on the microphone body 20 to control the functions and actions of the wireless microphone 2 with the display function. In addition, in this embodiment, it may also dispose an assist hand-held portion 25 onto the hand-held portion 201 to adapt the user, who has different request, to use conveniently.

The display 21 is disposed on the first opening 212 of the frame portion 202. The sound receiving unit 22 is disposed on the second opening 222 of the frame portion 202 to receive at least one sound signal from the exterior.

The memory module 23, which saves at least one display information, is electrically connected with the display 21. In addition, in this embodiment, the display information may be the character information or the image information.

Additionally, in this embodiment, it further disposes a wireless communication module 24 into the microphone body 20. The wireless communication module 24 may be a radio frequency (RF) wireless communication module, a Bluetooth wireless communication module 24, or a wireless local area network (WLAN) communication module. The wireless communication module 24 is respectively connected with the sound receiving unit 22 and the memory module. The wireless communication module 24 is used to deliver or receive the display information or at least one sound information. The sound information can be transferred from the sound signal, which received by the sound receiving unit 22 and then delivered to the corresponding receiving module by the wireless communication module 24. In addition, the display information can be delivered to the corresponding receiving module by the wireless communication module 24.

In this embodiment, the wireless communication module 24 is the Bluetooth wireless communication module, which at least includes a RF chip set and a baseband chip set. The RF chip set and baseband chip set can be integrated in a single package.

In summary, the wireless microphone with the display function has the display disposed on the frame portion to show the information and the memory module to save the display information. Thus, the user can directly read the requested information conveniently.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A wireless microphone with a display function, comprising:
a microphone body, which has a hand-held portion and a frame portion connected with the hand-held portion, wherein the frame portion has a first opening and a second opening;
a display, which is disposed in the first opening of the frame portion;
a sound receiving unit, which is disposed in the second opening of the frame portion, and receives at least a sound signal; and
a memory module, which is connected with the display, and saves at least one display information shown on the display.

2. The microphone according to claim 1, wherein the memory module is disposed in the microphone body.

3. The microphone according to claim 1, wherein the display information is text information.

4. The microphone according to claim 1, wherein the display information is image information.

5. The microphone according to claim 1, further comprising:
a wireless communication module, which is electrically connected with the memory module and the sound receiving unit respectively.

6. The microphone according to claim 5, wherein the wireless communication module is used for delivering or receiving the display information.

7. The microphone according to claim 5, wherein the wireless communication module is used for delivering or receiving at least one sound information.

8. The microphone according to claim 5, wherein the wireless communication module is a radio frequency (RF) wireless communication module.

9. The microphone according to claim 5, wherein the wireless communication module is a wireless local area network (WLAN) communication module.

10. The microphone according to claim 5, wherein the wireless communication module is a Bluetooth wireless communication module.

11. The microphone according to claim 10, wherein the Bluetooth wireless communication at least comprises an RF chip set and a baseband chip set.

12. The microphone according to claim 11, wherein the RF chip set and the baseband chip set are integrated in a single package.

13. The microphone according to claim 1, wherein the hand-held portion and the frame portion are integrally formed.

14. The microphone according to claim 1, wherein the microphone body further comprises a plurality of keys.

15. The microphone according to claim 1, wherein the hand-held portion further comprises an auxiliary hand-held portion.
